(19) United States
(12) Patent Application Publication
(10) Pub. No.: US 2008/0178143 A1
(43) Pub. Date: Jul. 24, 2008

(54) System, Method and Computer Program Product for Developing, Configuring, Installing and Testing Software

(76) Inventors: Cort Dougan, Socorro, NM (US); Victor J. Yodaiken, Austin, TX (US)

Correspondence Address: FAY KAPLUN & MARCIN, LLP, 150 BROADWAY, SUITE 702, NEW YORK, NY, 10038, US

(21) Appl. No.: 11/867,954

(22) Filed: Oct. 5, 2007

Related U.S. Application Data
(60) Provisional application No. 60/849,444, filed on Oct. 5, 2006.

(51) Int. Cl. G06F 9/44

(52) U.S. Cl. 717/100

(57) ABSTRACT

A system having a host operating system configured to be executed by a data processing unit, virtualization software configured to run as an application of the host operating system, a client operating system configured to be executed by the virtualization software and a software development system comprising one or more applications running as applications of the client operating system.

### BACKGROUND OF THE INVENTION

1. Field of the Invention

The present invention relates generally to a system, method and computer program product for developing, configuring, installing and testing software, such as, for example, embedded software.

2. Discussion of the Background

Existing systems that require both a development computer and external devices to develop and install embedded software have several limitations and drawbacks. Complex and specialized knowledge is required to compile and build target software on the development computer, update the development software periodically, configure the development computer to locate and operate a target, configure the operating system and other system software, configure firmware and boot-loader on the target, connect the target, build (and cross-compile) user provided source-code into executables, test the software, make a final install, package the software, etc. Due to the numerous steps involved, using both the development computer and the external devices can be error-prone and can slow down the development of the new software.

Thus, a need exists in the art for a system, method and computer program product that overcome at least one or more of the above deficiencies of the prior art

### SUMMARY OF THE INVENTION

The present invention provides such a desired system, method and computer program product. In one aspect, the present invention provides a system for developing software (e.g., embedded software, real-time software, and other software). In some embodiments, the system includes (1) a developer device, (2) an application device, and (3) a network that connects the developer device to the appliance device. The developer device has a developer control program and the appliance device has a communication server module that function together to enable a user of the developer device to transmit commands and data to the appliance device over the network. Typically, a developer uses the developer device to create source code, and the appliance device is adapted to compile the source code to create executable code for a target device. The appliance device may also be adapted to install the executable code on the target device and cause the target device to execute the executable code.

In another aspect, the present invention provides a method of developing software. A developer device is connected to an appliance device over a network. A user of the developer device (the “developer”) uses the developer device to transmit project information to the appliance device. For example, the project information may include information identifying the type of software for the project and information identifying a target device. The developer uses the developer device to create and edit source code. The source code is stored on a storage device that is accessible to the appliance device so that an application running on the appliance device can access the source code. After creating the source code, the developer instructs the appliance device to use the source code to create executable code for the target device. The appliance selects the appropriate cross-compiler and compiles the source code to create executable code.

In yet another aspect, the present invention provides a system for developing software. In some embodiments, the system includes a development means having a client application means for communication over a network. The development means is used by a developer to create source code. An appliance means having a communication server means for communication over the network with the development means. The appliance means is adapted to compile the source code to create executable code for a target means. The executable code is installed on and executed by the target means.

In another aspect, the invention provides a system for developing software, which system includes: a data processing unit; a display device in communication with the data processing unit; a host operating system configured to be executed by the data processing unit; virtualization software configured to run as an application of the host operating system; a client operating system configured to be executed by the virtualization software; and a software development system comprising one or more applications running as applications of the client operating system, wherein the software development system is configured to: (1) compile source code to create executable code for execution by a processor of a target device; (2) install the executable code on the target device; (3) cause the processor of the target device to execute the executable code; (4) receive data output from the target device as a result of the target device executing the executable code; and (5) display the received data on the display device.

The above and other aspects, features and advantages of the present invention, as well as the structure and operation of preferred embodiments of the present invention, are described in detail below with reference to the accompanying drawings.

### BRIEF DESCRIPTION OF THE DRAWINGS

The accompanying drawings, which are incorporated herein and form part of the specification, help illustrate various embodiments of the present invention and, together with the description, further serve to explain the principles of the invention and to enable a person skilled in the pertinent art to make and use embodiments of the invention. In the drawings, like reference numbers indicate identical or functionally similar elements.

FIG. 1 is a functional block diagram of the architecture for a system, method and computer program product according to an exemplary embodiment of the present invention.

FIG. 2 is a functional detailed block diagram of the developer device of FIG. 1 according to an exemplary embodiment of the present invention.

FIG. 3 is a functional detailed block diagram of the appliance device of FIG. 1 according to an exemplary embodiment of the present invention.

FIG. 4 is a functional detailed block diagram of the target device of FIG. 1 according to an exemplary embodiment of the present invention.

FIG. 5 is a flow diagram showing the steps in the process for the development, configuration, installation and testing of software according to an exemplary embodiment of the present invention.

FIG. 6 is a screen shot, according to one embodiment, of a portion of a user interface of an integrated development environment (IDE) component.

FIG. 7 illustrates a computer system according to another embodiment.

FIG. 8 is a functional block diagram of the developer device of FIG. 7 according to an exemplary embodiment of the present invention.

FIG. 9 illustrates the components of an IDE plug-in according to one embodiment.

FIG. 10 illustrates the components of a development kit according to one embodiment.

FIG. 11 illustrates an example configuration file for configuring a virtual machine.

### DETAILED DESCRIPTION OF PREFERRED EMBODIMENTS

In the following description, for purposes of explanation and not limitation, specific details are set forth, such as particular networks, communication systems, computers, terminals, devices, components, techniques, data and network protocols, software products and systems, enterprise applications, operating systems, enterprise technologies, middleware, development interfaces, hardware, etc., in order to provide a thorough understanding of the present invention. However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, enterprise applications, operating systems, enterprise technologies, middleware, development interfaces, and hardware are omitted so as not to obscure the description of the present invention.

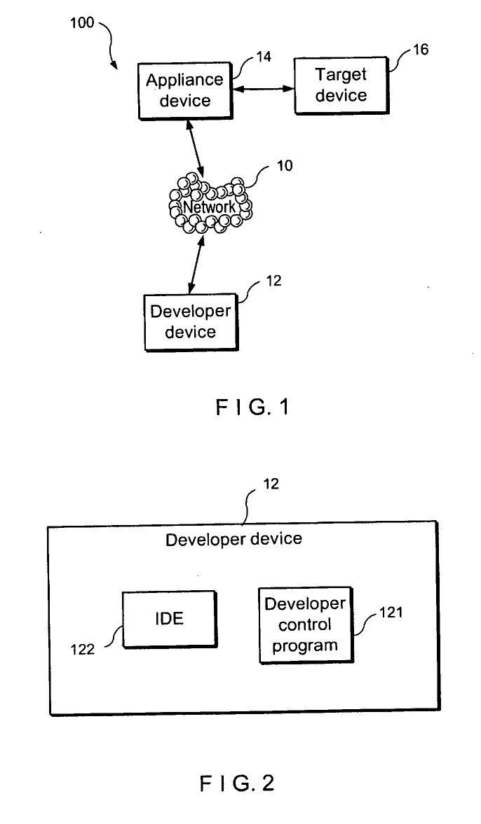

FIG. 1 is an illustration of a representative computer system 100 for implementing the systems, methods and computer program products of the present invention for developing software (e.g., embedded software, real-time software, and other software). Referring to FIG. 1, the system 100 comprises a developer device 12, an appliance device 14, and/or a target device 16. The developer device 12 is adapted to communicate with the appliance device 14 and/or the target device 16 over a network 10. The network 10 may be an intranet, internet, public network, private network, the Internet or the like, and may be wired, wireless or a hybrid. As will be appreciated by those skilled in the art, a single developer device 12 and single target device 16 are illustrated for simplicity. However, in practice, it is expected that multiple developer devices 12 will connect to the appliance device so that multiple developers can benefit from the features and functionality provided by the appliance device 14. Additionally, in practice, it is expected that many different types of target devices may be connected to appliance device 14 so that a developer may create software for any number of target devices.

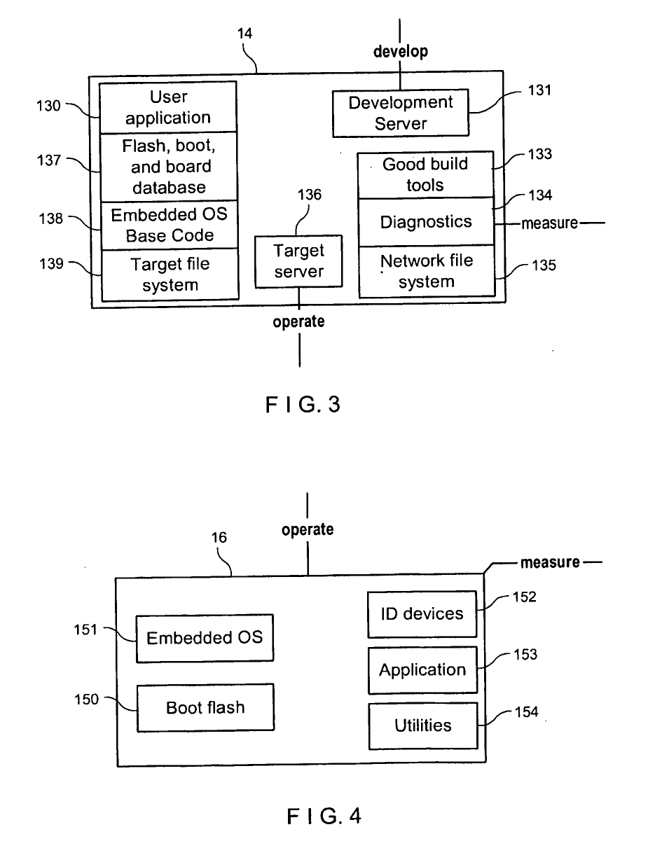

Referring now to FIG. 2, FIG. 2 illustrates developer device 12 according to some embodiments of the invention. As show in FIG. 2, the developer device 12 may include a developer control program 121 and an integrated development environment (IDE) component 122. The developer control program 121 may be, for example, a web browser. The developer control program 121 displays information on a display (not shown) of the developer device 12, for example, by interpreting HTML code that is used to build web pages.

In one embodiment of the present invention, a web page displayed on the display of the developer device 12 is used to configure the appliance device 14 (e.g., install software that connects the IDE component 122 with the appliance device 14, create one or more control windows, etc). The IDE component 122 can be, for example, Microsoft's Visual Studio or other IDE systems.

The developer device 12 may be any type of computing device that allows a developer (e.g., engineer, computer scientist, programmer, etc.) to communicate with the appliance device 14 and/or the target device 16. Preferably, the developer can create and edit source code, run tests, and execute commands using developer device 12. The developer may also manage licenses, users and other services provided to the user by the appliance device 14 using his/her developer device 12. Further, the developer can create and manage a file system on a removable media device for a given set of target devices 16 integrating user-provided software, system tools and an operating system (e.g., DVD, CD, compact flash, xD, USB mass storage devices, hard-disk or floppy). In addition, the developer can archive and manage deployed versions of user created packages of user-provided software, operating system and system tools. Training materials can be distributed, for example, via streaming media, FAQ, newsletters, white papers, app notes, eBooks, or the like, to a user using the developer device 12.

Referring back to FIG. 1, the appliance device 14 is designed to simplify and accelerate the process of developing software (e.g., real-time, embedded software) by automating installation, configuration and testing, and providing a specialized environment for development and testing. The appliance device 14 is configured to compile source code to create executable code (e.g., binaries, run-times, object code, executable programs, executable images, etc.) for the target device 16. The appliance device 14 operates the target device 16 by loading the executable code and installing file systems (e.g., flash, disk or other storage) in, for example, a boot flash memory 150 of the target device 16. The file systems may be network or local. In addition, the appliance device 14 checks the output of the target device 16, controls debugger operation, and measures and controls input/output (I/O) devices 152, which will be described in detail below.

In some embodiments, the appliance device 14 has at least two interfaces: (1) a “develop” interface and (2) an “operate” interface. A third interface, (e.g., a “measure” interface) may also be added. The “develop” interface connects the developer device 12 to the appliance device 14. In some embodiments, the “develop” interface is an Ethernet port.

The “operate” interface connects the appliance device 14 to the target device 16. The “operate” interface allows the appliance device 14 to install executable code on and communicate with the target device 16. Preferably, the “operate” interface is an Ethernet port and a Joint Test Access Group (JTAG) port used together.

The “measure” interface is used to control the environment of the target device 16. Preferably, the “measure” interface is a set of Digital I/O and/or Analog/Digital ports on a typical A/D board.

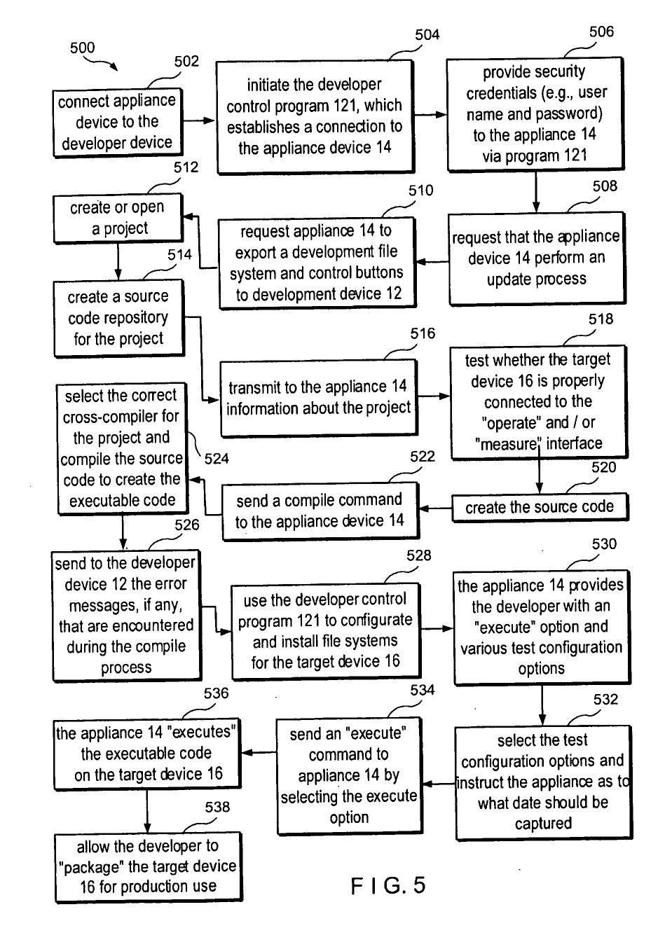

Referring now to FIG. 3, FIG. 3 illustrates components of appliance device 14 according to some embodiments. As shown in FIG. 3, appliance device 14 may include a user application 130, a development server 131, cross build tools 133, a diagnostic system 134, a network file system 135, a target server 136, a flash, boot and board database 137, operating system code 138, and a target file system 139.

The development server 131 acts as a web server for communicating with the developer device 12 over the network 10. The diagnostic system 134 monitors the environment of the target device 16. The target server 136 facilitates communication between the developer device 12 and the target device 16.

Preferably, a developer using developer device 12 can transmit commands to appliance device 14 that cause appliance device to communicate with a connected target device via the “operate” interface. Additionally, the developer may transmit commands to appliance device 14 that cause appliance device to communicate with a connected target device via the “measure” interface.

When the developer creates source code using the developer device 12, the source code may be transparently stored or copied to the user application 130 of the appliance device 14 (e.g., via the “develop” interface) (or development server 131). Next, the developer instructs the appliance device 14 to compile the source code by instructing the IDE component 122 of the developer device 12 to send a “build/compile program” or “make” command to the appliance device.

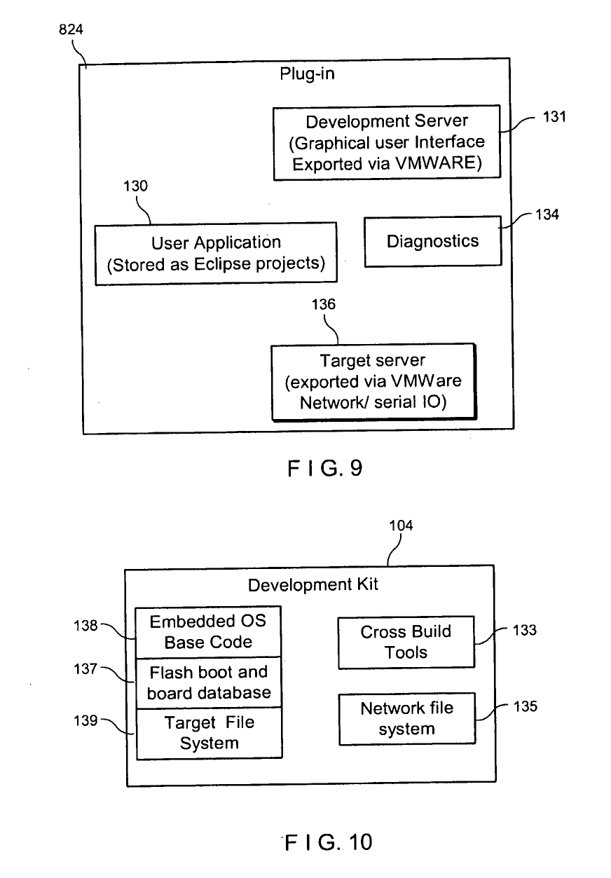

For example, in some embodiments, IDE component 122 is configured to provide a command menu to the developer and the developer instructs IDE component 122 to send the “make” command to appliance 14 by selecting a “make” command option from the command menu. FIG. 6 is a screen shot, according to one embodiment, of a portion of a user interface 600 of IDE component 122. As shown in FIG. 6, user interface 600 may include a command menu 602 that enables a developer to instruct IDE component to send commands to appliance 14. In the example shown, command menu 602 includes four commands: Make, Run, Stop, and Option.

After receiving the make command, the appliance device 14 compiles the source code using the user application 130, the base operating system code 138 and/or the cross build tools 133 of the appliance device 14, such that executable code (e.g., binaries, run-times, object code, executable programs, executable images, etc.) is created. Error messages that are created during the compile process and/or code analysis data may be maintained on the appliance device 14 and sent to the developer device 12 so that the developer can review the error messages. Further, all modifications, revisions and revision control information for code development may be transparently maintained on the appliance device 14 and sent to the developer device 12.

After the appliance 14 has created the executable code, the developer may instruct the appliance device 14 to install the executable code on the target device 16 or serve the executable images to the target device 16 for execution. In some embodiments, the developer instructs the appliance device 14 to install the executable code on the target device 16 by instructing IDE component 122 to send an “execute code” command to the appliance 14. For example, the IDE component 122 may display a menu of commands to the developer, wherein if the developer selects one of the commands the IDE 122 transmits the “execute code” command to appliance 12. In response to receiving the “execute code” command, the appliance 12 may send the executable code to the target device 16, e.g., via the “operate” interface.

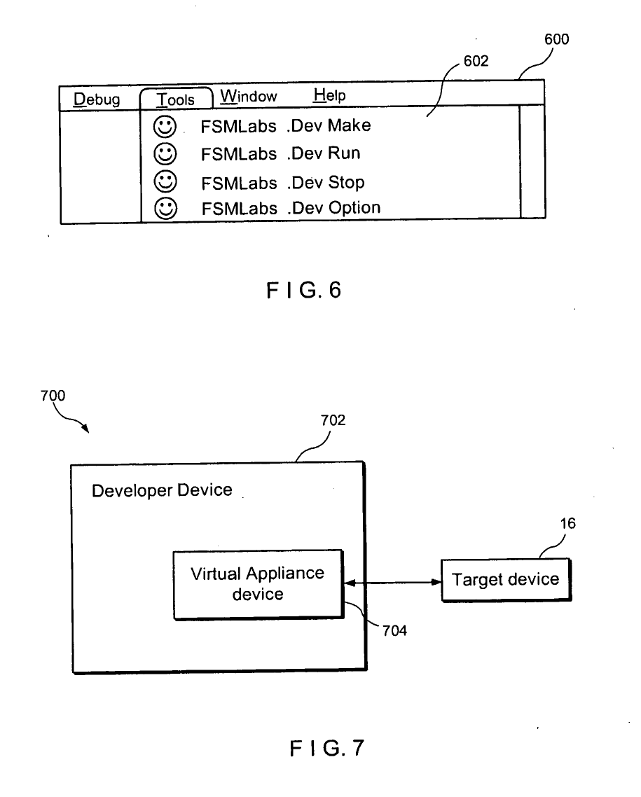

Referring now to FIG. 4, FIG. 4 illustrates an embodiment of a target device 16. As shown in FIG. 4, the target device 16 may include boot flash memory 150, operating system base code 151, I/O devices 152, user applications 153, and utilities 154.

The target device 16 can be a single board computer, cell-phone handset, consumer electronic device, or any device that requires programming. In an exemplary embodiment of the present invention, the target device 16 and the appliance device 14 are separate and distinct devices. In another embodiment, the target device 16 and the appliance device 14 are the same, and the appliance device 14 executes the executable code.

As discussed above, the appliance device 14 communicates with the target device 16 and sends the executable code to the target device 16 for installment. In one embodiment, a developer can provide simulated input to test the target device 16 once the executable code is installed on the target device 16. The input can be varied depending on the output from the target device 16. In another embodiment, the developer can automate scheduled testing, and automate scheduled build/test of the executable code.

In some embodiments, appliance 14 records the output from the target device 16, and a database of target architectures can also be maintained, such that different target devices 16 can be used. In addition, the databases can be used to switch to the appropriate functions required for different target architectures.

Patches, updates and new software can be delivered to and integrated automatically into the target device 16, e.g., over the network 10, via physical media, etc. Reports (e.g., bug reports) can be delivered to the appliance device 14 from the target device 16.

Appliance 12 may be adapted to configure operating system features for the target device 16. In addition, network file systems can be configured and served to the target device 16 to reduce development cycle time. In one embodiment, the target device 16 receives the operating system 151, user applications 153 and utilities 154 over the network 10 from the target file system 139 of the appliance device 14. In another embodiment, the target device 16 receives the operating system 151, user applications 153 and utilities 154 from the boot flash memory 150 after the executable code is installed on the target device 16 using the board database 137.

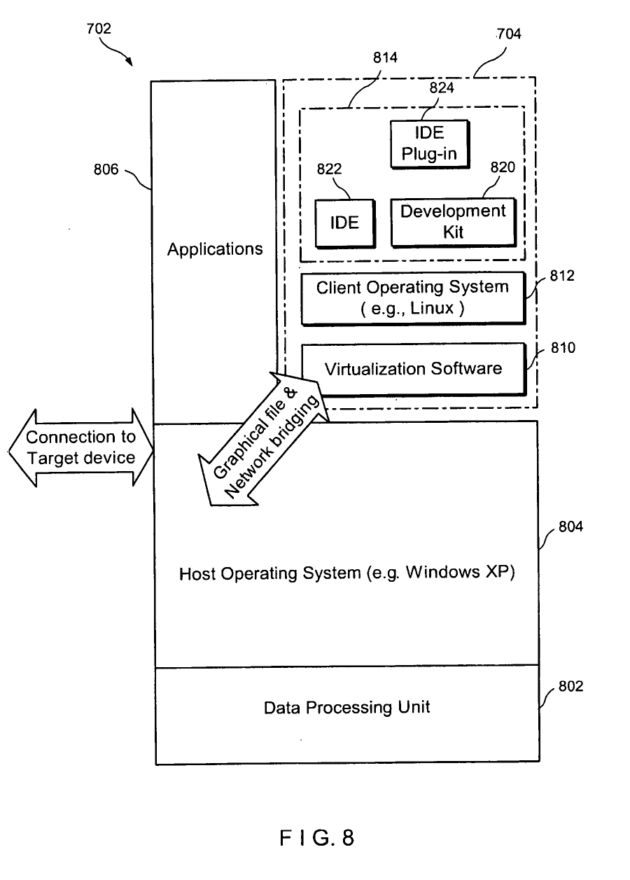

Referring now to FIG. 5, FIG. 5 is a flow diagram showing the steps in a process 500 for the development, configuration, installation and testing of software according to an exemplary embodiment of the present invention. Process 500 may begin in step 502, where appliance device 14 is connected directly to the developer device 12 (e.g., via a USB, Ethernet, Firewire, or other connection) or to an accessible network and given a fixed address or URL and the target device is connected to the appliance 14 via the “operate” interface.

In step 504, the developer initiates the developer control program 121, which establishes a connection to the appliance device 14. In step 506, the developer provides security credentials (e.g., user name and password) to the appliance 14 via program 121 and the appliance device 14 checks permissions, licenses, installed software, etc.

In step 508, the developer may request that the appliance device 14 perform an update process. For example, if the developer requests an update, the appliance 14 obtains updated, documentation, new training materials, other content, etc., from a remote server.

In step 510, the developer, via the developer control program 121, requests appliance 14 to export a development file system and “control buttons” (e.g., menu 602 or other control buttons) to development device 12. In response, appliance 14 checks permissions/capabilities and exports the file system and control button to the developer device 12. The control buttons provide a means for the developer device 12 to trigger operations on the appliance 14.

In step 512, the developer creates or opens a project either directly in the development control program or in the IDE. In response, appliance 14 creates a source code repository for the project (step 514). In step 516, the developer, via the developer control program 121, transmits to the appliance 14 information about the project. The information may include the type of software being developed and type of target device and/or an identifier identifying the target device.

In step 518, the appliance 14 tests whether the target device 16 is properly connected to the “operate” and/or “measure” interface. In step 518, appliance 14 may also determine whether the target device 16 works with the base operating system (OS) software by testing the ability of the target device by testing the ability of the target device to load and execute the base operating system software and measuring its performance. The base operating system software is the operating system that will run on the target device to support the application. It is expected that this base operating system software will be installed on the Appliance device.

In step 520, the developer writes and edits source code. The source code may be stored on the appliance 14 or the development device 12. If the developer wants appliance 14 to compile the source code and if the source code is not accessible to appliance 14, the source code is transmitted to the appliance 14 or otherwise stored on a storage device to which appliance 14 has access.

In step 522, when the developer wants appliance 14 to compile the source code, the developer sends a compile command to the appliance device 14. In response, the appliance device 14 selects the correct cross-compiler for the project and compiles the source code to create the executable code (step 524). The errors, if any, that are encountered during the compile process are sent to the developer device 12 and are displayed in the display of the developer device 12 (step 526). As a convenience, the developer can use the source code repository to view changes or differences, or to revert to earlier versions of the source code.

In step 528, the developer uses the developer control program 121 to configure and install file systems for the target device 16. The file systems may be either network or local file systems (e.g., flash or disk or other storage). Part of this step can involve options to select what software will be available on the target device 16, the size of the target file system, and configuration of the target (e.g. network and display configuration). In some embodiments, the appliance 14 exports either web pages or options on an IDE that allow the developer to configure these options. In the case of a web page, the page may permit the developer to select options and enter parameters which will be then transferred to the appliance and incorporated into a rule base.

In step 530, the appliance 14 provides the developer with an “execute” or “run” option and various test configuration options. For example, appliance 14 may transmit a web page to program 121, which web page enables the developer to select an execute option and the various test configuration options. The test configuration options may include an option to run a debugger and/or install breakpoints.

In step 532, the developer selects the test configuration options and instructs appliance 14 as to what data should be captured via the operate and measure interfaces and how the data should be displayed. In step 534, the developer sends an “execute” command to appliance 14 by selecting the execute option described above.

In response to receiving the execute command, the appliance 14 “executes” the executable code on the target device 16 (step 536). The execution process can involve a series of steps. For example, the step may involve the following: (1) exporting a file system including the executable code for use by the target device l6; (2) powering on the target device 16; (3) supplying a boot kernel to the target device 16; (4) monitoring the target device's boot process; (5) providing debug control to the target device 16 (e.g., via a JTAG interface, by running as a remote debugger, etc); (6) displaying execution data from the target device 16 on the display of the developer device 12; (7) collecting measurements, tracing, profiling and other information from the target device 16 and sending the collected information to the developer control program 121 and to a log file; and (8) analyzing the collected data and providing analytic information to the program 121, which may display and/or store the analytic information.

In step 538, the appliance 14 may allow the developer to “package” the target device 16 for production use. This may involve the appliance 14 installing a flash file system on the target device 16, encryption of installed software, turning on lock bits, and other steps to prevent modification of released products or to make startup simpler.

The systems, methods and computer program products for developing, configuring, installation and testing software according to the present invention solves at least some of the deficiencies of the prior art. In an exemplary embodiment of the present invention, a developer using the developer device of the present invention creates source code. The appliance device of the present invention compiles the source code to create executable code for a target device to operate the target device. The developer performs the steps of developing, configuring, installation and testing software using the developer device and appliance device, thereby reducing the chance of errors and increasing time for the development of the new software.

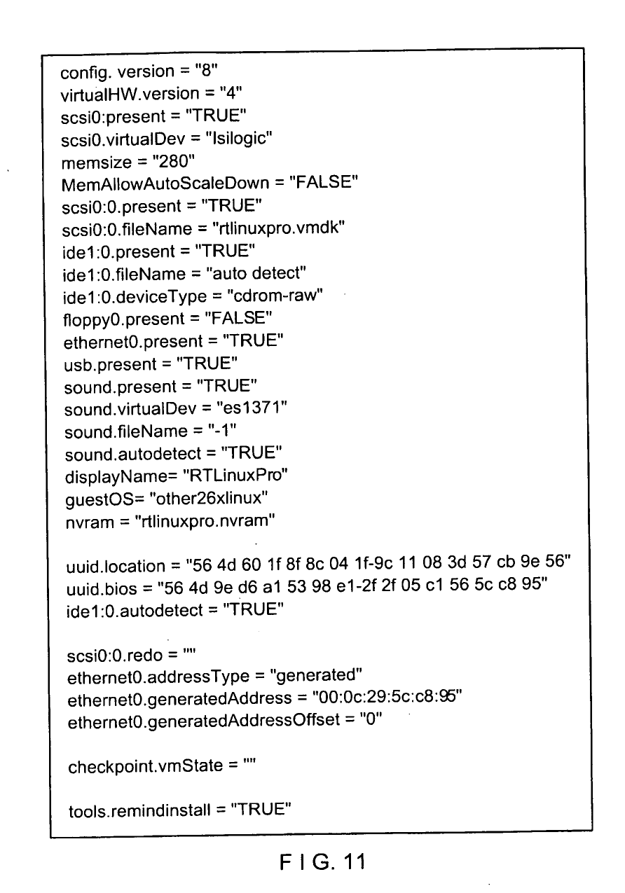

Referring now to FIG. 7, FIG. 7 illustrates a computer system 700, according to another embodiment, for implementing the systems and methods for developing software (e.g., embedded software, real-time software, and other software). Referring to FIG. 7, system 700 comprises a developer device 702, a virtual appliance device 704 that runs on the developer device, and a target device 16 communicatively coupled to the developer device 702. Virtual appliance device 704 is configured to provide much of the same functionality as appliance device 14.

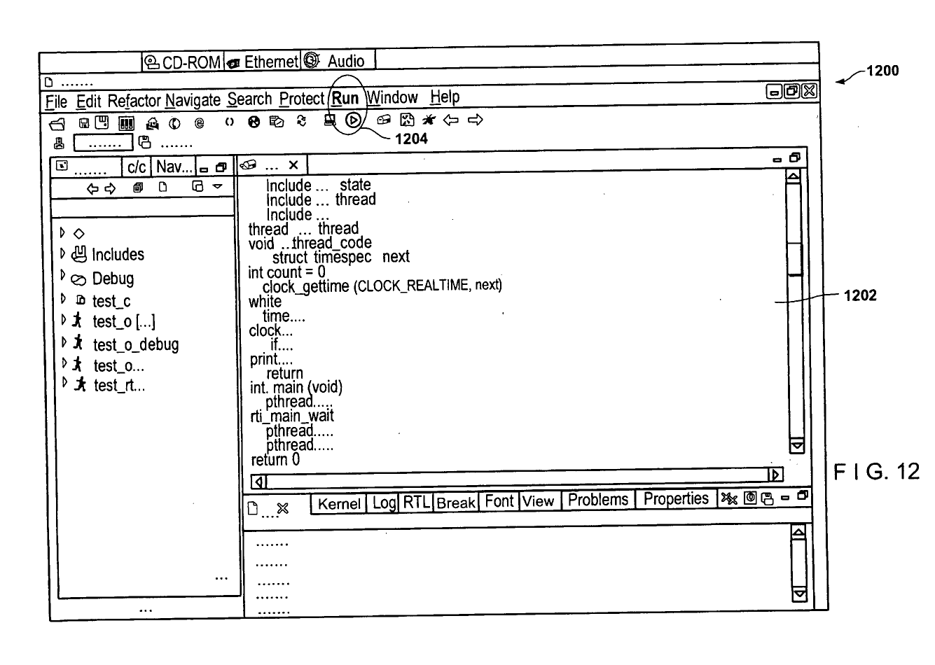

Referring now to FIG. 8, FIG. 8 is a block diagram of developer device 702, according to one embodiment. As shown in FIG. 8, device 702 includes: (1) a data processing unit 802, which unit may include one or more processors and other chips; (2) a host operating system 804 (e.g., an operating from Microsoft® or other operating system) which can be executed by the processing unit 802; (3) applications 806 configured to run as applications of operating system 804 (e.g., control program 121); and (4) virtual appliance device 704, which is configured to run as an application of operating system 804.

As shown in FIG. 8, virtual appliance device 704 comprises virtualization software 810 (e.g., VMWare Workstation or VMWare Player, both of which are available from VMWare, Inc.), an operating system 812 (e.g., Linux or a Unix like operating system or other operating system) configured to be executed by virtualization software 810; and a software development system 814, the components of which are configured to run as applications of operating system 812.

In one embodiment, software development system 814 may include a development kit 820 (e.g., the RTLinuxPro development kit available from FSMLabs, Inc. of Socorro, N. Mex. or other like development kit), an IDE 822 (e.g., a Java based IDE such as the one available from the Eclipse Foundation of Ottawa, Ontario Canada—see www.eclipse.org); and an IDE plug-in 824.

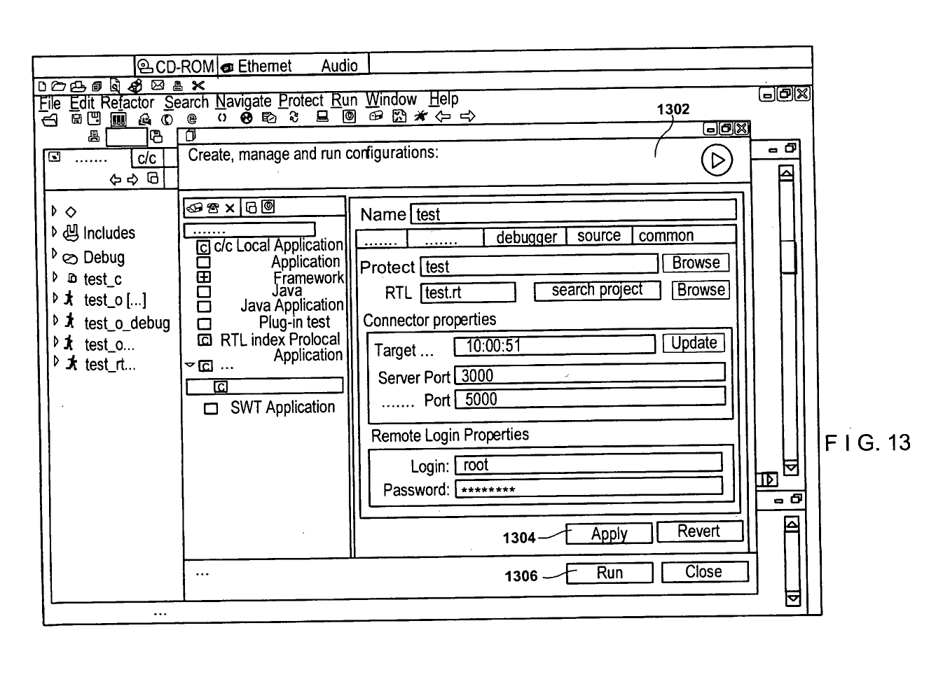

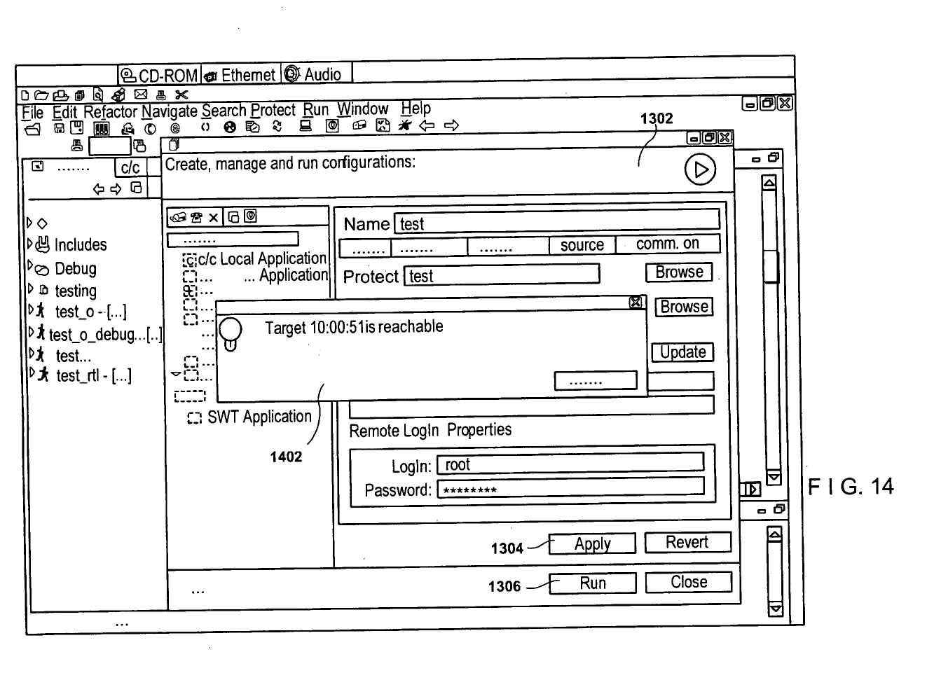

Referring now to FIGS. 9 and 10, FIG. 9 illustrates the components of plug-in 824, according to one embodiment, and FIG. 10 illustrates the components of development kit 820, according to one embodiment. As shown in FIG. 9, plug-in 824 may include the following components: user application 130, target server 136, diagnostic system 134, and development server 131. As shown in FIG. 10, development kit 820 may include the following components: embedded OS code base 138, database 137, file system 139, tools 133 and file system 135. Accordingly, as illustrated in FIGS. 9 and 10, virtual appliance device 704 includes many of the same components as appliance device 14, thus enabling virtual appliance device to replace appliance device 14.

As illustrated in FIGS. 7 and 8, the appliance device 14 is implemented by a “virtual machine instance” executing on the developer device 702. In this embodiment, a single physical computer (e.g., device 702) provides the functions of both developer device 12 and appliance device 14. More specifically, a virtual machine emulator executing on device 702 (e.g. one provided by VMWare, such as VMWare Workstation) is used to encapsulate the software of the appliance device 14. To create one such embodiment, a VMWare virtual machine player or workstation may be installed on the developer device 702 (which may be a PC or Workstation running Microsoft Windows operating system) and a virtual machine instance is provided to the virtual machine player/workstation. The virtual machine instance, in one embodiment, includes an instance of the Linux operating system, a complete set of compilers, tools, and libraries provided by the RTLinuxPro Development kit, a Java virtual machine (JVM) and the a version of the Eclipse Integrated Development Environment (IDE) with appropriate plug-ins to manage projects for the target device 16.

In one embodiment, the operating system 812 can be pre-configured to start IDE 822 as the operating system 812 begins executions so that the operation of the operating system 812 is hidden from the developer using the development device 702. The developer will see only a graphical user interface of IDE 822 running on the device 702 and will not need to be aware of the operation of the virtual machine environment at all.

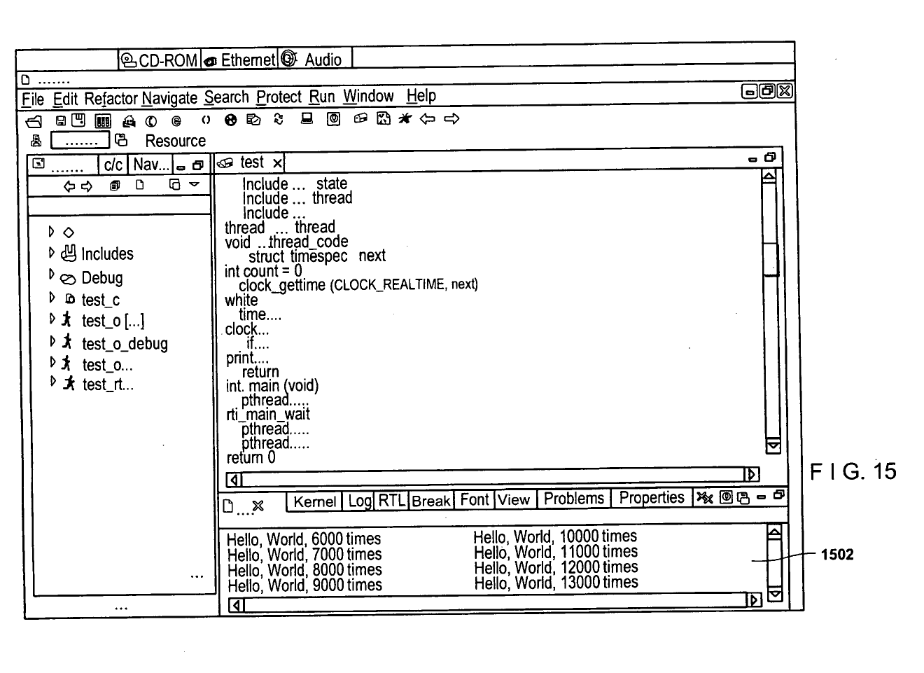

In some embodiments, the steps a developer performs to construct the virtual appliance device 704 are as follows: (1) install the virtualization software 810 on the developer device 702; (2) install on the device 702 a virtual machine configuration file (FIG. 11 illustrates an example configuration file), which configuration is read by software 810 and is used to configure features of software 810; and (3) install on device 702 an image file (e.g., a .VMDK file), which file is a virtual storage unit that contains operating system 812 and software development system 814. The configuration file may include a pointer to the image file.

In one embodiment, to reduce the initial size of the image file, the image file provided to a developer contains a compressed version of the software development system 814 (and other files possibly) (e.g., the development system 814 and other files may be stored in a tar file). In this embodiment, the image file includes operating system 812's kernel, a one-time initialization program, a second initialization program (which may be compressed), and a compressed version of development system 814.

The kernel is configured to execute a predetermined initialization program each time the kernel is loaded (e.g., the program named “init” that is found in the /sbin directory) and the image file is configured such that the first time the kernel is executed by the virtualization software 810, the kernel executes the one-time initialization program, which functions essentially only to decompress the development system 814 and any other compressed files, execute the second initialization program (or “true” initialization program), and configure the system such that each subsequent time the kernel is loaded, the kernel will execute the true initialization program. Accordingly, in some embodiments, initially, every file stored in the image file may be compressed, with the exception of the kernel, one-time initialization program and the files that are needed by the one-time initialization program to perform its functions.

In some embodiments, the first time the true initialization program is executed, the developer is asked to agree to the terms of a license. Preferably, after the developer agrees to the license, operating system 812 is configured to automatically start up IDE 822 and cause IDE 822 to cover the entire desktop of operating system 812, thus appearing as a single application instead of a hosted operating system.

In this second exemplary embodiment, the virtualization software 810 performs many of the functions of the “network” 10 by connecting the graphical display of the virtual machine instance to the graphical display of the host operating system 804 (e.g., Microsoft Windows in one embodiment). The software 810 will also provide an emulated network and enable sharing of files and file systems between the host operating system 804 and the client operating system 812. Accordingly, the developer will be able to create and modify: (1) files that are accessible to operating system 804 and its applications, but not accessible to client operating system 812, (2) files that are accessible to both host operating system 804 and client operating system 812, and (3) files that are accessible only to operating system 812 and its applications.

In this second exemplary embodiment, the IDE of FIG. 2 runs within the virtual appliance device 704 and its graphical user interface is exported using the virtual machine graphical device export to thereby appear as if the IDE were directly executing as an application of host operating system 804, rather than directly executing as an application of client operating system 812.

In this second exemplary embodiment, the target server 136 and diagnostics component 134 connect to the development server 131 using virtualized network connections provided by the virtualization software 810 and tunneled through the physical network devices of the development device to appear like remote network connections on the target device 16. The development server component 131 connects to the developer device using the same virtualized network, shared memory, shared files, or some combination of these.

One variation of the above described virtual application device embodiment moves IDE 822 from the virtual machine instance to execute directly on the developer device (i.e., to run as an application of host operating system 804). In this variation, the steps of FIG. 5 are unchanged from the user point of view.

Referring now to FIGS. 12-15, these figures illustrate use of the virtual appliance device 704 by a developer. Referring to FIG. 12, FIG. 12 shows the desktop that is displayed on the display screen of the developer's developer device 702. As illustrated in FIG. 12, the developer in this scenario is running the Windows operating system as the host operating system 804 and has launched the virtualization software, which has executed the client operating system 812, which has automatically launched the development system 814, a user interface 1200 of which is shown in FIG. 12.

User interface 1200 includes a source code display area 1202 for displaying the source code that the developer is developing and various control elements (e.g., buttons, pull-down menus, etc.) for activating functionality of system 814. For example, interface 1200 may include a control element that when activated causes system 814 to compile the source code to create an executable file corresponding to the source code. If the developer would like to install the executable file on a target device and have the target device execute the executable file, the developer may select the “Run” option 1204.

After the user selects the run option 1204, the user may be requested to select a target device. After the developer selects the target device, the developer may be presented with a user interface 1302, which user interface enables the developer to specify, among other things, the network address of the target device, one or more port numbers, and login information. After the developer specifies the information, the developer can activate the “apply” button. In response, system 814 may determine whether the target is reachable. If the target is reachable, system 814 may display a pop-up window 1402 (see FIG. 14) informing the developer that the target device is reachable. At the point, if the developer still wants to install the executable file on a target device and have the target device execute the executable file, the developer would select the “run” button 1306.

In response to the developer activating the “run” button 1306, system 814 may (1) transmit a copy of the executable file to the target device with data instructing the target device to install the executable file, (2) issue a command to the target device that causes the target device to execute the executable file, (3) receive data produced by the target device as a result of the target device executing the executable file, and (4) display at least some of the data in a data display consol 1502 (see FIG. 15) of user interface 1200 so that the developer can view the data.

As FIGS. 12-15 illustrates, a developer can use a conventional computer (e.g., an Intel-based computer) running a conventional operating system (e.g., Windows) to create source code for a target device, compile the source code into an executable file, install the executable file on the target device, cause the target device to execute the executable file, and view data output from the target device to determine whether the target device as programmed by the executable file is functioning as intended.

While a various embodiments of the present invention have been described above, it should be understood that it has been presented by way of example only, and not limitation. Thus, the breadth and scope of the present invention should not be limited by any of the above described exemplary embodiments.

Additionally, while the processes described above and illustrated in the drawings are shown as a sequence of steps, this was done solely for the sake of illustration. Accordingly, it is contemplated that some steps may be added and other steps omitted, and the order of the steps may be re-arranged. In other words, any sequence or order of steps that may be described does not necessarily indicate a requirement that the steps be performed in that order. The steps of processes described herein may be performed in any order practical. Further, some steps may be performed simultaneously.

What is claimed is:

1. A system, comprising:
a host operating system configured to be executed by a data processing unit;
virtualization software configured to run as an application of the host operating system;
a client operating system configured to be executed by the virtualization software; and
a software development system comprising one or more applications running as applications of the client operating system.

2. The system of claim 1, wherein the software development system is configured to compile source code to create executable code for execution by a processor of a target device.

3. The system of claim 2, wherein the software development system is further configured to install the executable code on the target device.

4. The system of claim 2, wherein the software development system is further configured to cause the processor of the target device to execute the executable code.

5. The system of claim 2, wherein the software development system is further configured to receive data output from the target device as a result of the target device executing the executable code.

6. The system of claim 5, wherein the software development system is further configured to display the received data on a display device.

7. The system of claim 1, wherein the software development system includes one of a user application, a target server, a diagnostic system and a development server.

8. The system of claim 1, wherein the software development system includes one of an embedded operating system code base, a database having one of boot information and board information, a target file system, a build tool and a network file system.

9. The system of claim 2, wherein the software development system includes a graphical user interface displayed on a display device, the graphical user interface displaying the source code to a user.

10. The system of claim 9, wherein the graphical user interface further includes one of a first user control element to initiate compiling of the source code, a second user control element to initiate installation of the compiled source code on the target device, and a third user control element to initiate execution of the compiled source code on the target device.

11. The system of claim 2, wherein the software development system includes a graphical user interface displaying representations of a plurality of target devices.

12. A method, comprising:
executing, by a data processing unit, a host operating system;
executing virtualization software as an application of the host operating system;
executing a client operating system by the virtualization software; and
executing a software development system as one or more applications running as applications of the client operating system.

13. The method of claim 12, wherein the executing of the software development system includes compiling source code to create executable code for execution by a processor of a target device.

14. The method of claim 13, wherein the executing of the software development system further includes initiating installation of the executable code on the target device.

15. The method of claim 13, wherein the executing of the software development system further includes initiating the processor of the target device to execute the executable code.

16. The method of claim 13, wherein the executing of the software development system further includes receiving data output from the target device as a result of the target device executing the executable code.

17. The method of claim 16, wherein the executing of the software development system further includes displaying the received data on a display device.

18. The method of claim 13, wherein the executing of the software development system includes displaying a graphical user interface on a display device, the graphical user interface displaying one of the source code to a user, a first user control element to initiate compiling of the source code, a second user control element to initiate installation of the compiled source code on the target device, and a third user control element to initiate execution of the compiled source code on the target device.

19. The method of claim 13, wherein the executing of the software development system includes displaying a graphical user interface displaying representations of a plurality of target devices and receiving a selection of one of the plurality of target devices.

20. A system, comprising a memory storing a set of instructions and a processor configured to execute the instructions, the instructions being operable to:
virtualize an operation of a a client operating system; and
virtualize a software development system comprising one or more applications running as applications of the client operating system, wherein the software development system is configured to (1) compile source code to create executable code for execution by a processor of a target device, (2) install the executable code on the target device, (3) cause the processor of the target device to execute the executable code, (4) receive data output from the target device as a result of the target device executing the executable code, and (5) display the received data on a display device.
